(19) United States
(12) Patent Application Publication
(10) Pub. No.: US 2007/0195041 A1
(43) Pub. Date: Aug. 23, 2007

(54) Liquid crystal display device having improved side visibility

(75) Inventor: Jun-Pyo Lee, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/709,416

(22) Filed: Feb. 21, 2007

(30) Foreign Application Priority Data
Feb. 22, 2006 (KR) 2006-17273

(51) Int. Cl. G09G 3/36

(52) U.S. Cl. 345/89

(57) ABSTRACT

A liquid crystal display device having optimal side visibility stores gray scale data corresponding to the input data signals in a look-up table. Each pixel of a liquid crystal panel includes two sub-pixels, and a controller of the liquid crystal display device applies a data voltage having different levels to the sub-pixels using the look-up table data.

### CROSS-REFERENCE TO RELATED APPLICATION

This application relies for priority upon Korean Patent Application No. 2006-17273 filed on Feb. 22, 2006, the contents of which are herein incorporated by reference.

### FIELD OF THE INVENTION

The present invention relates to a liquid crystal display device and an improved method of setting the gray levels for the display.

### DESCRIPTION OF THE RELATED ART

The liquid crystal display device includes two substrates separated by a liquid crystal layer to which an electric field is applied. The device displays images because the applied electric field controls light transmittance through the liquid crystal layer. However, liquid crystal display devices employing a large-sized liquid crystal panel may distort images depending on the viewing position with respect to a screen.

### SUMMARY OF THE INVENTION

The present invention provides a liquid crystal display device having an improved display quality, especially when viewed from the side. In addition, the present invention provides a method of setting gray levels of the liquid crystal display device. In one aspect of the present invention, each pixel PX is divided into two sub-pixels and data voltages having different gray levels are applied to the sub-pixels to improve side visibility. The data voltages are based on a look-up table storing the gray scale data corresponding to the input image data signals.

An exemplary liquid crystal display device includes a liquid crystal panel, a controller, a data driver, and a gate driver. The liquid crystal panel includes a plurality of pixels aligned in a matrix form and displays images in response to a gate voltage, a first data voltage and a second data voltage. The controller provides first and second control signals in response to the image data signals and reads out gray scale data corresponding to the image data signals to output first and second gray scale signals having different gray scale levels. The data driver outputs the first and second data voltage having different levels in response to the first control signal and the first and second gray scale signals. The gate driver outputs the gate voltage in response to the second control signal.

In another aspect of the present invention, the liquid crystal display device is driven as follows. Gray scale data corresponding to the input image data signals are prepared. First and second gray scale signals having different gray scale levels are output corresponding to the image data signals. Then, first and second data voltage having different levels are output in response to a first control signal and the first and second gray scale signals. A gate voltage is output in response to a second control signal. Images are displayed in response to the gate voltage and the first and second data voltages.

In still another aspect of the present invention, the liquid crystal display device sets gray scale levels as follows. First, gamma curves of first and second sub-pixels, which allow a liquid crystal panel to have optimal side visibility, are set. Then, the data voltage of the same gray level is applied to the first and second sub-pixels. The luminance of the liquid crystal panel on which images corresponding to the applied data voltage are displayed is measured to detect the gamma curve in front of the liquid crystal panel. Gray scale levels to be applied to the first and second sub-pixels are detected by using the set gamma curves of the first and second sub-pixels and the detected gamma curve, and then the detected gray levels are stored in a look-up table.

### BRIEF DESCRIPTION OF THE DRAWING

The above and other advantages of the present invention will become from a reading of the following detailed description when considered in conjunction with the accompanying drawings, wherein:

FIG. 1 is a block diagram showing an exemplary embodiment of a liquid crystal display device according to the present invention;

FIG. 2 is an equivalent circuit diagram for a pixel of the liquid crystal panel shown in FIG. 1;

FIG. 3 is a graph showing gamma curves representing luminance properties according to the gray scale levels applied to the liquid crystal panel 100;

FIG. 4 is a look-up table formed in storage by using the gamma curves shown in FIG. 3;

FIGS. 5A and 5B are graphs showing gamma curves depending on colors of input image data signals;

FIG. 6 is a flowchart showing the procedure of forming the look-up table shown in FIG. 4; and

FIG. 7 is a flowchart showing the operational procedure of a liquid crystal display device using the look-up table shown in FIG. 4.

### DESCRIPTION OF THE EMBODIMENTS

In the present invention, a liquid crystal display device employs vertical alignment modes of the liquid crystal in order to improve side visibility. In the vertical alignment modes, liquid crystal molecules are vertically aligned in the absence of an applied electric field but are aligned substantially perpendicular to the electric field when voltage is applied to the liquid crystal. Among the vertical alignment modes, a super-patterned vertical alignment (S-PVA) mode divides each pixel PX into two sub-pixels PXA and PXB and adjusts the voltage applied to the liquid crystal such that the voltage applied relative to sub-pixel PXA is different from the voltage applied relative to sub-pixel PXB. The difference of the voltage applied to the liquid crystal relative to the two sub-pixels PXA and PXB induces a transmittance difference, thereby improving the side visibility of the liquid crystal display device. The present invention provides a method of applying data voltages having different gray levels in order to allow the liquid crystal to be charged with different voltages relative to the two sub-pixels PXA and PXB.

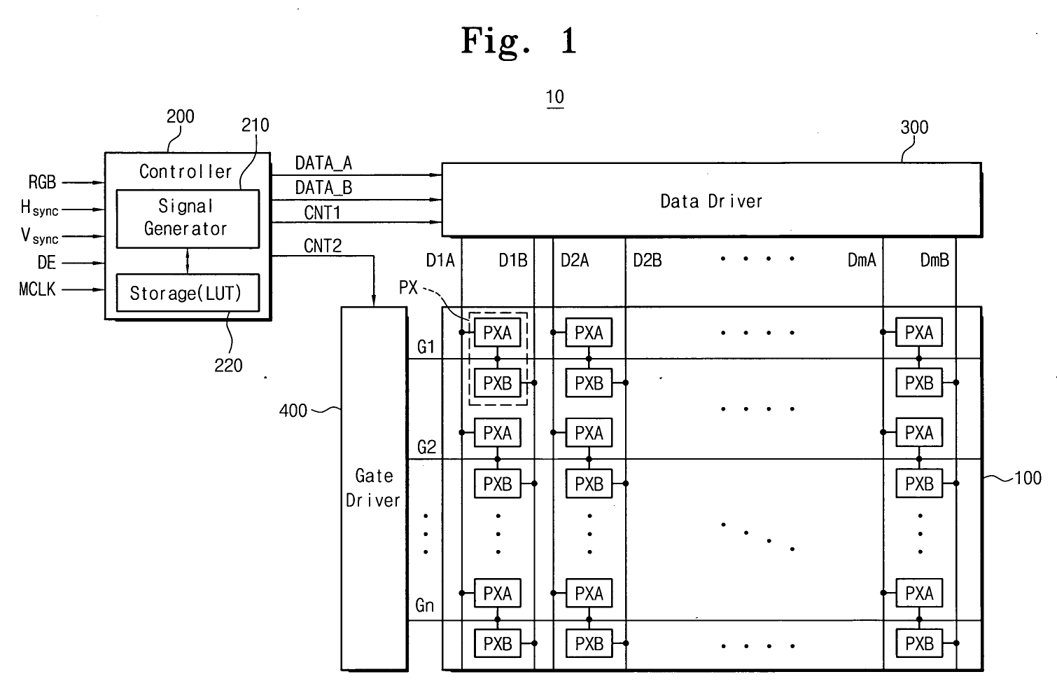

FIG. 1 is a block diagram showing an exemplary embodiment of a liquid crystal display device according to the present invention.

Referring to FIG. 1, the liquid crystal display device 10 includes a liquid crystal panel 100 displaying images, a controller 200 outputting control signals, a data driver 300 outputting data line driving signals, and a gate driver 400 outputting gate line driving signals.

The liquid crystal panel 100 includes a substrate having a common electrode and a substrate having pixel electrodes with a liquid crystal layer between the two substrates. The substrate having the pixel electrodes includes a plurality of data lines D1A to DmB, a plurality of gate lines G1 to Gn, and a plurality of pixels PX arranged in a matrix form. Each of the pixels PX includes first and second sub-pixels PXA and PXB which are respectively connected to data lines D1A and D1B and one gate line G1. The data lines D1A to DmB are aligned in a column direction of the liquid crystal panel 100, and gate lines G1 to Gn are aligned in a row direction of the liquid crystal panel 100.

Controller 200 receives red, green and blue image data signals R, G and B, a horizontal synchronous signal Hsync, a vertical synchronous signal Vsync, a clock signal MCLK, and a data enable signal DE from an external graphic source (not shown). Controller 200 outputs first and second data signals DATA_A and DATA_B having the data format converted to be suitable for the operating requirements of liquid crystal panel 100, and first and second control signals CNT1 and CNT2. The first and second data signals DATA_A and DATA_B and the first control signal CNT1 are applied to data driver 300, and the second control signal CNT2 is applied to the gate driver 400. The first and second data signals DATA_A and DATA_B, which are output from controller 200, include gray scale level information of the images to be displayed on the liquid crystal panel 100.

In detail, controller 200 includes a signal generator 210 and storage 220 for storing, in look-up table (LUT) form, gray scale data corresponding to the gray scale levels of the input image data signals R, G and B. The gray scale data stored in the storage 220 include first and second gray scale data having different gray scale values with respect to one gray scale level.

The first gray scale data is applied to data driver 300 as the first data signal DATA_A. The first gray scale data is converted into a first data voltage by data driver 300 and applied to the first sub-pixel PXA of the liquid crystal panel 100 through the first data line D1A. Similarly, the second gray scale data is applied to data driver 300 as the second data signal DATA_B. The second gray scale data is converted into a second data voltage by data driver 300 and applied to the second sub-pixel PXB of the liquid crystal panel 100 through the second data line D1B.

Signal generator 210 detects the gray scale levels of the input image data signals R, G and B and reads out the first and second gray scale data corresponding to the detected gray scale levels from the LUT of the storage 220, and outputs the first and second gray scale data as the first and second data signals DATA_A and DATA_B.

Data driver 300 outputs data line driving signals through the data lines D1A to DmB of the liquid crystal panel 100 in response to the first and second data signals DATA_A and DATA_B and first control signal CNT1, which are provided from controller 200. Each data line driving signal becomes the data voltage applied to each pixel PX of the liquid crystal panel 100. The first control signal CNT1 applied to data driver 300 from controller 200 includes various signals such as a horizontal synchronization start signal STH, a load signal LOAD, a data clock signal HCLK, etc.

Gate driver 400 outputs the gate line driving signals through gate lines G1 to Gn in response to the second control signal CNT2. Each gate line driving signal becomes the gate voltage applied to each pixel PX of the liquid crystal panel 100. The gate voltage turns on or turns off thin film transistors corresponding to the pixels PX, respectively. The second control signal CNT2 applied to the gate driver 400 from controller 200 includes various signals such as a vertical synchronization start signal STV, a gate clock signal CPV, an output enable signal OE, etc.

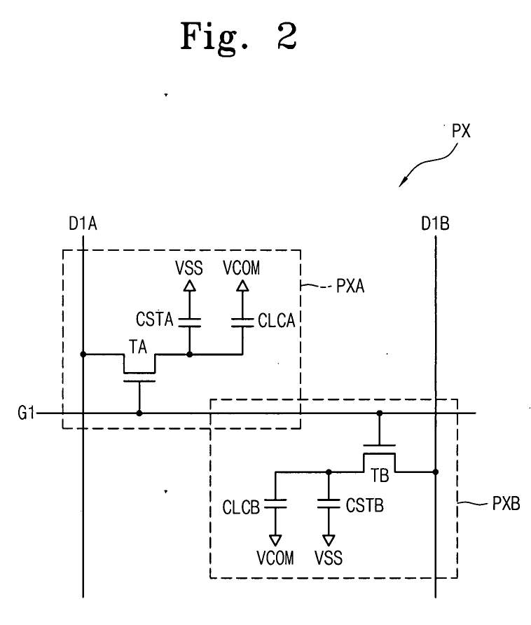

FIG. 2 is an equivalent circuit diagram for each pixel PX of the liquid crystal panel shown in FIG. 1. Referring to FIG. 2, each of the pixels PX of the liquid crystal panel 100 includes a first sub-pixel PXA and a second sub-pixel PXB. The first sub-pixel PXA is connected to the first data line D1A and the first gate line G1, and includes a first thin film transistor TA, a first storage capacitor CSTA, and a first liquid crystal capacitor CLCA. The first thin film transistor TA includes a gate connected to the first gate line G1, a source connected to the first data line D1A, and a drain connected to the first storage capacitor CSTA.

The second sub-pixel PXB is connected to the second data line D1B and the first gate line G1, and includes a second thin film transistor TB, a second storage capacitor CSTB, and a second liquid crystal capacitor CLCB. The second thin film transistor TB includes a gate connected to the first gate line G1, a source connected to the second data line D1B, and a drain connected to the second storage capacitor CSTB.

The first and second data lines D1A and D1B are connected with data driver 300 and apply the data voltage of different levels to the first and second sub-pixels PXA and PXB, respectively. The first gate line G1 is connected with the gate driver 400. The gate voltage applied through the first gate line G1 substantially simultaneously turns on or turns off the first and second thin film transistors TA and TB of the first and second sub-pixels PXA and PXB.

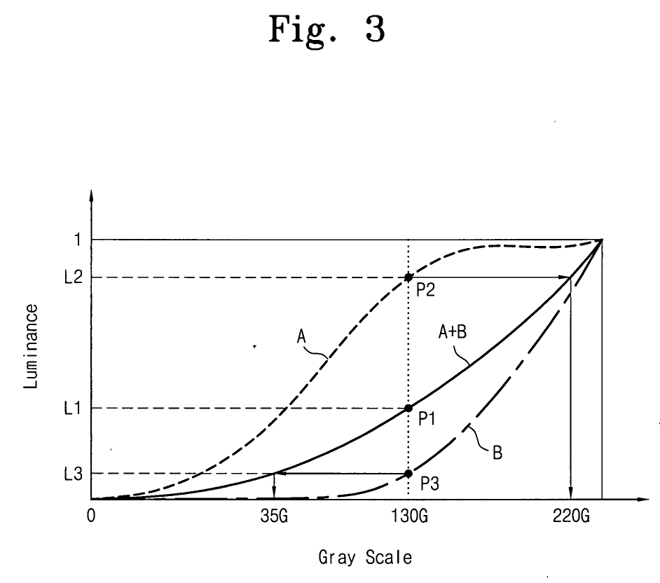

FIG. 3 is a graph showing gamma curves representing luminance properties according to the gray scale levels applied to the liquid crystal panel 100. Gamma curve A of the first sub-pixel PXA and gamma curve B of the second sub-pixel PXB which allow the liquid crystal panel 100 to have optimal side visibility are set in the process of fabricating the liquid crystal display device 10. Both gamma curve A of the first sub-pixel PXA and gamma curve B of the second sub-pixel PXB may vary depending on characteristics and functions of the liquid crystal display device 10.

Data voltage representing the same gray scale level is applied to sub-pixels PXA and PXB and then the luminance property in front of the liquid crystal panel 100 is detected, thereby obtaining gamma curve A+B in front of the liquid crystal panel 100. The LUT in the storage 220 is formed based on the measured luminance from gamma curve A+B.

For example, when the data voltage corresponding to the same first gray scale 130G is applied to the first and second sub-pixels PXA and PXB of the liquid crystal panel 100, a first luminance value L1 is detected in front of the liquid crystal panel 100. A second contact point P2 making contact with gamma curve A of the first sub-pixel PXA and a third contact point P3 making contact with gamma curve B of the second sub-pixel PXB are obtained by linearly extending a first contact point P1, at which the first gray scale 130G applied to the liquid crystal panel 100 meets the first luminance value L1 detected from the liquid crystal panel 100, in the luminance axis direction. On gamma curve A of the first sub-pixel PXA, the second contact point P2 has a second luminance value L2. On gamma curve A+B in front of the liquid crystal panel 100, a gray scale corresponding to the second luminance value L2 becomes a second gray scale 220G. Similarly, on gamma curve B of the second sub-pixel PXB, the third contact point P3 has a third luminance value L3. On gamma curve A+B in front of the liquid crystal panel 100, a gray scale corresponding to the third luminance L3 becomes a third gray scale 35G.

In other words, in order to express the gamma characteristic in front of the liquid crystal panel 100 as the first contact point P1, the data voltage corresponding to the second gray scale 220G must be applied to the first sub-pixel PXA, and the data voltage corresponding to the third gray scale 35G must be applied to the second sub-pixel PXB.

In this manner, the gray scale levels to be applied to the first and second sub-pixels PXA and PXB in correspondence with each gray scale of the image data signals R, G and B can be prepared in the form of the LUT. At this time, in order to detect accurately gray scale levels corresponding to the desired gamma curves of the first and second sub-pixels PXA and PXB, a dithering method can be used.

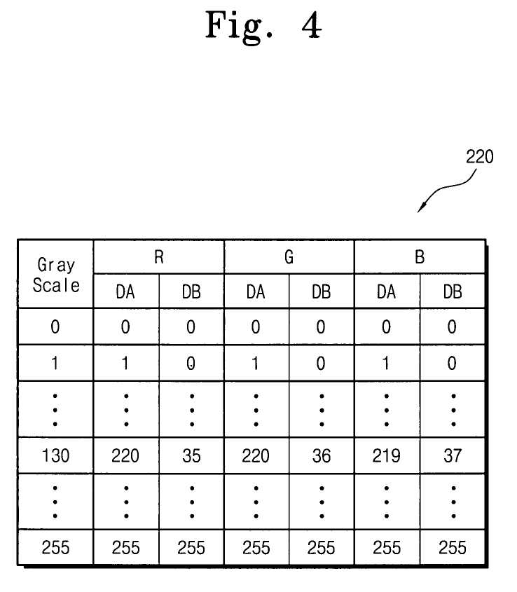

FIG. 4 shows an LUT stored in a storage using the gamma curves shown in FIG. 3. Referring to FIG. 4, the LUT stored in the storage 220 includes first and second gray scale data DA and DB corresponding to the gray scale levels of the red image data signal R, green image data signal G, and blue image data signal B, which are input from the outside.

In FIG. 4, the LUT for the liquid crystal display device 10 having 256 gray scale levels (between 0 and 255) is shown as an example. However, the configuration and format of the LUT can be variously modified according to driving capability of the liquid crystal display device 10.

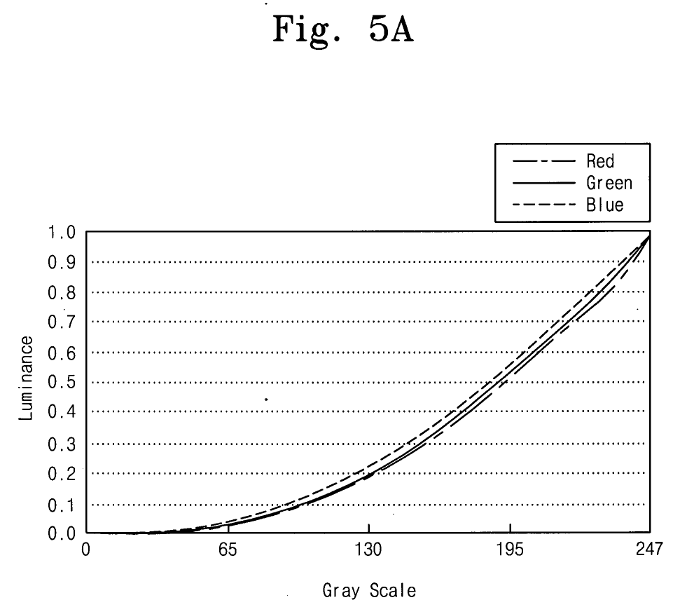

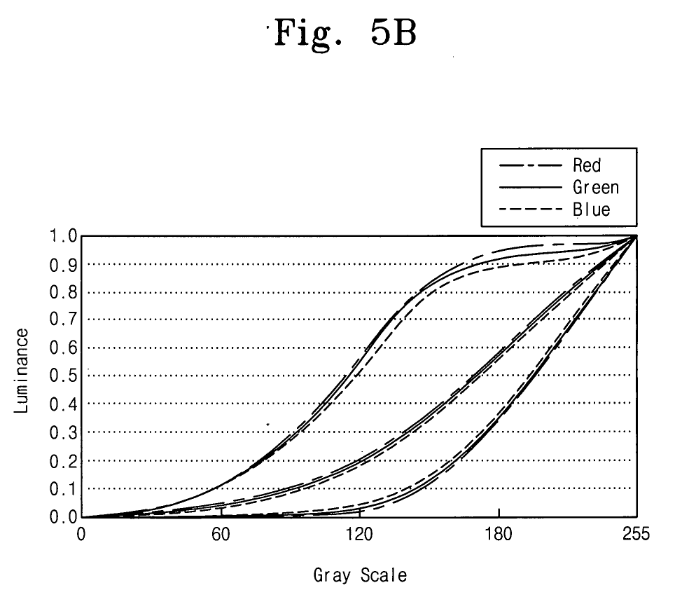

FIGS. 5A and 5B are graphs showing gamma curves depending on the colors of the input image data signals. Referring to FIG. 5A, the gamma curves vary depending on colors of the image data signals R, G and B input from the outside. This is because of a “color shift” phenomenon representing the shift of a color temperature and a chromaticity coordinate depending on the gray scale levels applied to the liquid crystal display device 10. In order to cope with this “color shift” phenomenon, an accurate color capture (ACC) technique has been proposed to adjust the gray scale levels of the red image data signal R, green image data signal G, and blue image data signal B, respectively, which are input from the outside.

FIG. 5B is a graph showing gamma curves depending on colors of image data signals after the ACC is applied. The LUT of the storage 220 shown in FIG. 4 includes the first and second gray scale data DA and DB corresponding to the gray scale levels of the red, green and blue image data signals R, G and B, so that the first and second gray scale data DA and DB depending on the colors can be readily varied. In other words, the gamma curves A and B of the first and second sub-pixels PXA and PXB depending on the colors can be adjusted by adjusting the first and second gray scale data DA and DB of the LUT of the storage 220. Accordingly, gamma curve A+B in front of the liquid crystal panel 100 may be adjusted depending on the colors.

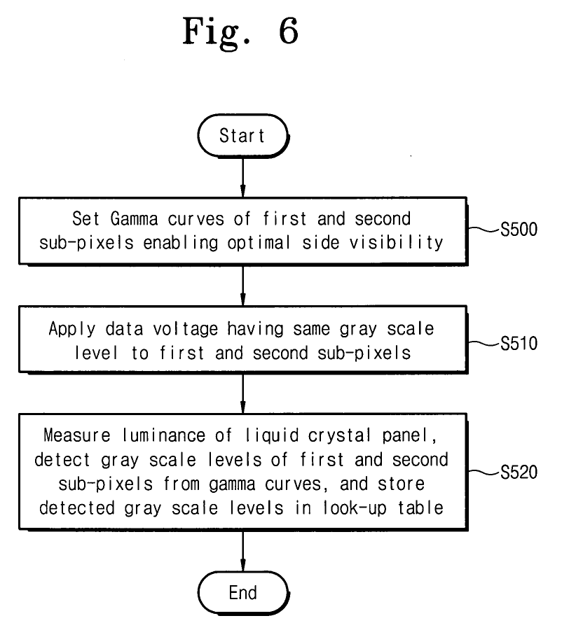

FIG. 6 is a flowchart showing the procedure of forming the LUT of FIG. 4.

Referring to FIG. 6, gamma curves A and B of the first and second sub-pixels PXA and PXB, which allow the liquid crystal panel 100 to have optimal side visibility, are set in the process of fabricating the liquid crystal display device 10 (S500). Then, the data voltage of the same gray scale level is applied to the first and second sub-pixels PXA and PXB of the liquid crystal panel 100 (S510).

Gamma curve A+B in front of the liquid crystal panel 100 is obtained by detecting luminance property in front of the liquid crystal panel 100, and an LUT is stored in the storage 220 by using gamma curve A+B in front of the liquid crystal panel 100, and the preset gamma curves A and B of the first and second sub-pixels PXA and PXB (S520).

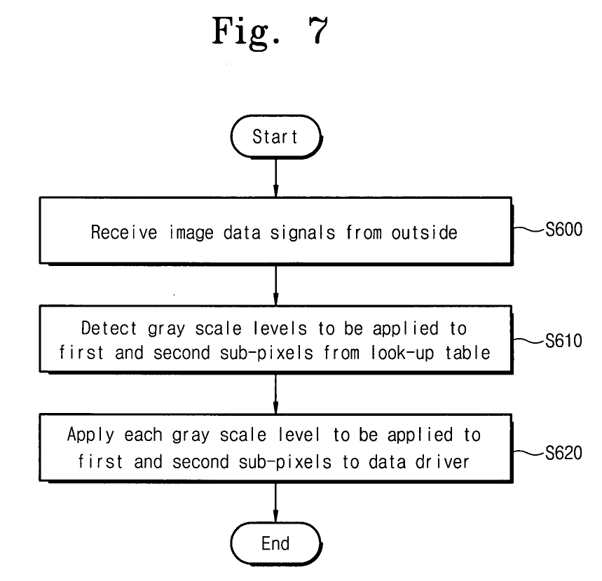

FIG. 7 is a flowchart showing the operational procedure of a liquid crystal display device using the LUT of FIG. 4.

Referring to FIG. 7, controller 200 of the liquid crystal display device 10 receives the image data signals R, G and B from the outside (S600). Then, controller 200 detects the first and second gray scale data from the LUT, which are expected to be applied to the first and second sub-pixels PXA and PXB of the liquid crystal panel 100 in correspondence with gray scale levels of the image data signals R, G and B (S610).

Controller 200 applies the first and second gray scale data detected from the LUT to data driver 300 as first and second data signals DATA_A and DATA_B (S620). Data driver 300 converts the first and second data signals DATA_A and DATA_B provided from controller 200 into the data voltages, and then applies the converted data voltages to the first and second sub-pixels PXA and PXB of the liquid crystal panel 100, respectively.

According to the above, each pixel of the liquid crystal panel is divided into two sub-pixels, and a data voltage having different level is applied to each sub-pixel using the LUT stored with the gray scale data corresponding to the image data signals input from the outside. Thus, the side visibility of the liquid crystal display device can be improved.

Although the exemplary embodiments of the present invention have been described, it is understood that various changes and modifications will be apparent to those of ordinary skill in the art and can be made without, however, departing from the spirit and scope of the present invention.

What is claimed is:

1. A liquid crystal display device comprising:
a liquid crystal panel having a plurality of pixels aligned in a matrix form and displaying images in response to a gate voltage, a first data voltage and a second data voltage;
a controller having gray scale data corresponding to input image data signals input, outputting first and second control signals in response to the image data signals, and reading out the gray scale data corresponding to the image data signals to output first and second gray scale signals having different gray scale levels;
a data driver outputting the first and second data voltage having different levels in response to the first control signal and the first and second gray scale signals; and
a gate driver outputting the gate voltage in response to the second control signal.

2. The liquid crystal display device of claim 1, wherein the controller comprises:
a storage storing the gray scale data corresponding to the gray scale levels of the image data signals; and
a signal generator detecting the gray scale levels of the image data signals, reading out the gray scale data corresponding to the detected gray scale levels from the storage, and applying the first and second gray scale signals to the data driver.

3. The liquid crystal display device of claim 2, wherein the gray scale data stored in the storage comprise first and second gray scale data having different gray scale values in correspondence with one gray scale level of the image data signals.

4. The liquid crystal display device of claim 3, wherein the image data signals comprises red, green and blue image data signals, and the storage stores the first and second gray scale data corresponding to gray levels of the red, green, and blue image data signals, respectively.

5. The liquid crystal display device of claim 2, wherein the storage comprises an electrically erasable and programmable read-only memory (EEPROM).

6. The liquid crystal display device of claim 1, wherein a gray scale level of the first-gray scale signal is higher than that of the second gray scale signal, and a level of the first data voltage is higher than that of the second data voltage.

7. The liquid crystal display device of claim 1, wherein each of the pixels comprises:
first and second thin film transistors;
first and second pixel electrodes connected with drains of the first and second thin film transistors respectively;
a gate line having the gate voltage applied thereto, and commonly connected to gates of the first and second thin film transistors;
a first data line having the first data voltage applied thereto, and connected with a source of the first thin film transistor; and
a second data line having the second data voltage applied thereto, and connected with a source of the second thin film transistor.

8. A liquid crystal display device comprising:
a liquid crystal panel having a plurality of pixels aligned in a matrix form and displaying images in response to a gate voltage, a first data voltage, and a second data voltage;
a controller having gray scale data corresponding to image data signals input from an exterior, outputting first and second control signals in response to the image data signals, and reading out the gray scale data corresponding to the image data signals to output first and second gray scale signals having different gray scale levels;
a data driver outputting the first and second data voltage having different levels in response to the first control signal and the first and second gray scale signals; and
a gate driver outputting the gate voltage in response to the second control signal,
wherein each of the pixels comprises:
first and second thin film transistors;
first and second pixel electrodes connected with drains of the first and second thin film transistors respectively;
a gate line having the gate voltage applied thereto, and commonly connected to gates of the first and second thin film transistors;
a first data line having the first data voltage applied thereto, and connected with a source of the first thin film transistor; and
a second data line having the second data voltage applied thereto, and connected with a source of the second thin film transistor.

9. The liquid crystal display device of claim 8, wherein the controller comprises:
a storage storing the gray scale data corresponding to the gray scale levels of the image data signals; and
a signal generator detecting the gray scale levels of the image data signals, reading out the gray scale data corresponding to the detected gray scale levels from the storage, and applying the first and second gray scale signals to the data driver.

10. The liquid crystal display device of claim 9, wherein the gray scale data stored in the storage comprises first and second gray scale data having different gray scale values in correspondence with one of the gray scale levels of the image data signals.

11. The liquid crystal display device of claim 10, wherein the image data signals comprise red, green, and blue image data signals, and the storage individually stores the first and second gray scale data corresponding to each of the gray scale levels of the red, green, and blue image data signals.

12. The liquid crystal display device of claim 9, wherein the storage comprises an electrically erasable and programmable read-only memory (EEPROM).

13. The liquid crystal display device of claim 8, wherein a gray level of the first gray scale signal is higher than that of the second gray scale signal, and a level of the first data voltage is higher than that of the second data voltage.

14. A method of driving a liquid crystal display device, the method comprising:
preparing gray scale data corresponding to input image data signals,
outputting first and second control signals in response to the image data signals,
reading out the gray scale data corresponding to the image data signals and outputting first and second gray scale signals having different gray scale levels;
outputting first and second data voltages having different levels in response to the first control signal and the first and second gray scale signals;
outputting a gate voltage in response to the second control signal; and
displaying images in response to the gate voltage, the first data voltage and the second data voltage.

15. The method of claim 14, wherein the outputting of the first and second gray scale signals comprises:
storing the gray scale data corresponding to gray scale levels of the image data signals; and
detecting the gray scale levels of the image data signals, reading out the gray scale data corresponding to the detected gray scale levels from the stored gray scale data to apply the first and second gray scale signals.

16. The method of claim 14, wherein a gray scale level of the first gray scale signal is higher than that of the second gray scale signal, and a level of the first data voltage is higher than that of the second data voltage.

17. A method of setting gray scale levels of a liquid crystal display device, the method comprising:
setting gamma curves of first and second sub-pixels allowing a liquid crystal panel to have optimal side visibility;
applying data voltages of a same gray scale level to the first and second sub-pixels;
detecting luminance of the liquid crystal panel on which images corresponding to the applied data voltages are displayed, and detecting a gamma curve in front of the liquid crystal panel; and
detecting gray scale levels to be applied to the first and second sub-pixels by using the set gamma curves of the first and second sub-pixels and the detected gamma curve, and storing the detected gray scale levels in a look-up table.

18. The method of claim 17, wherein the liquid crystal panel comprises a plurality of pixels aligned in a matrix form, and each of the pixels comprises the first and second sub-pixels.

19. The method of claim 18, wherein the first sub-pixel comprises a first thin film transistor, a first pixel electrode connected with a drain of the first thin film transistor, a gate line connected with a gate of the first thin film transistor, and a first data line connected with a source of the first thin film transistor, and the second sub-pixel comprises a second thin film transistor, a second pixel electrode connected with a drain of the second thin film transistor, a gate line connected with a gate of the second thin film transistor, and a first data line connected with a source of the second thin film transistor.

20. A method of driving a liquid crystal display device having a plurality of pixels aligned in a matrix form, each of said pixels being divided into sub-pixels having respective luminance versus gray scale characteristics, comprising:
detecting gray scale levels of input image data signals;
deriving data voltages for each of the sub-pixels corresponding to the detected gray scale levels of the input image data signals; and
applying the derived data voltages to corresponding ones of the sub-pixels.

21. The method of claim 20 wherein said step of deriving said data voltages comprises:
separately applying a voltage corresponding to a gray level to each of said sub-pixels and storing the resulting separate luminance levels;
jointly applying equal data voltages corresponding to a gray level to each of the sub-pixels and storing the resulting joint luminance level;
determining for each input data image signal the corresponding stored joint luminance level; and
reading out from storage the separate data voltages corresponding to the joint luminance level.
